(19) United States
(12) Patent Application Publication
(10) Pub. No.: US 2009/0184435 A1
(43) Pub. Date: Jul. 23, 2009

(54) CONTROLLING THE SYNTHESIS AND GEOMETRY OF LIPID TUBULE NETWORKS

(75) Inventors: Yung-Chieh Tan, Cupertino, CA (US); Liang Ma, University City, MO (US)

Correspondence Address: PATRICK W. RASCHE (15060);ARMSTRONG TEASDALE, LLP, ONE METROPOLITAN SQUARE, SUITE 2600, SAINT LOUIS, MO, 63102-2740, US

(73) Assignee: Washington University in St. Louis, St. Louis, MO (US)

(21) Appl. No.: 12/330,322

(22) Filed: Dec. 8, 2008

Related U.S. Application Data
(60) Provisional application No. 61/012,156, filed on Dec. 7, 2007.

(51) Int. Cl. B01J 13/18; B28B 1/54

(52) U.S. Cl. 264/4.7; 425/5

(57) ABSTRACT

Nano-sized lipid vesicles with tailored properties are used as building blocks to generate lipid tubules between two glass surfaces. The tubules formed not only have defined orientation, width, and length, but they can also grow to be as long as 13 mm under ambient conditions, without externally supplied flow, temperature control, or catalyzing agents. The tubule membrane and its internal aqueous content can be manipulated by controlling the combination of different vesicle's lipid composition and aqueous entrapment. This self-assembly process opens up new pathways for generating complicated and flexible architectures for use in biocompatible molecular and supramolecular engineering. Aspects of the invention generate, for example, tubules encapsulated with siRNA, tubules with multiple branches, and polymerized fluorescent tubules in a single-throughput self-assembly process.

### CROSS REFERENCE TO RELATED APPLICATION

This application claims the benefit of U.S. Provisional Application No. 60/012,156 filed Dec. 7, 2007, which is hereby incorporated by reference in its entirety.

### STATEMENT REGARDING FEDERALLY SPONSORED RESEARCH & DEVELOPMENT

This invention was made with United States Government support under N.I.H. grants HD41492 and ES014482S. The United States Government may have certain rights in the invention.

### BACKGROUND

Molecular self-assembly has generated a wide variety of interest due to its potential in synthesizing technologically useful micro/nanostructures (Lehn, J.-M., Angew. Chem., Int. Ed. Engl., 1990, 29:1304-1319). One well known structure generated by the molecular self-assembly of phospholipids in aqueous solution is a lipid vesicle, which consists of a bi-layered lipid membrane enclosing an aqueous core (Bangham, A. D. et al., J. Mol. Biol., 1965, 13:238). By tailoring desired properties to the membrane and encapsulating functional molecules within the core, vesicles can become biomimetic devices that have functionalities of their own. Many applications have already been demonstrated by using vesicles as vehicles for drug delivery (Zhu, N. et al., Science, 1993, 261(18):209) and as bioreactors for protein synthesis (Noireaux, V. et al., Proc. Natl. Acad. Sci. U.S.A., 2005, 101(51):17669). Interestingly, lipid vesicles can further organize into microstructures, including reversible aggregates (Chiruvolu, S. et al., Science, 1994, 264(17):1753), vesosomes (Walker, M. T. et al., Nature, 1997, 387:61), entangled tubules (Douliez, J.-P. et al., J. Colloid. Interf. Sci., 2003, 266:477 and Chiruvolu, H. E. et al., Science, 1994, 266(18):1222), and tubular networks (Akiyoshi, A. et al., FEBS Lett., 2003, 534:33 and Nomura, S.-i. M. et al., Biochim. Biophys. Acta, 2005, 1669:164). These structures have been of great interest due to their potential to be used as biomimetic machines, controlled release systems and biological membrane models. The ability of a single vesicle to function on its own and the ability for groups of vesicles to self-assemble into higher ordered structures make it possible for nano-sized vesicles to be used as building blocks for creating a variety of macroscopic structures. Yet the methods used to achieve the self-assembly of these structures have often limited the type of vesicles that can be used, and hence the complexity of the self-assembled structures is limited. By using a new self-assembly method, nano-sized vesicles are able to organize into tubules of defined orientation, length, and width. Further, this method allows different vesicle membranes and contents to be incorporated directly into tubules, thereby making it possible to engineer materials through combining the properties of different vesicles.

### SUMMARY

Embodiments of the invention are directed to a composition for generating lipid tubules, a technique for generating lipid tubules, a method for controlling the orientation, width, length, and/or shape of tubules, and a method for controlling the geometry of tubule networks. In an embodiment, conditions are provided wherein lipid vesicles self-assemble into a tubule structure. Other aspects of tubule synthesis are contemplated and within the scope of the embodiments of the invention.

An embodiment of the invention is directed to a method for making lipid tubules, the method comprising depositing an aqueous solution comprising lipid vesicles onto a substrate, confining the aqueous solution to a region comprising a top, a bottom, perimeter and a center, and allowing the aqueous solution to evaporate at the perimeter. Under such conditions, the lipid tubules self-assemble.

In an embodiment, lipid vesicles self-assemble into tubules. The tubules are generally straight, and elongate generally perpendicular to the plane of growth. The tubules have hollow interiors comprising the same encapsulated content as the lipid vesicles from which the tubules are grown. The tubules are generally elastic and allow fluidic volumes to travel from the proximal end to the distal end. In an embodiment, the tubules are synthesized without ethanol. A wide range of biological substances may be encapsulated into the lipid vesicles first, and into the tubules made therefrom.

Light microscopy images may be used to view the synthesis and resulting tubule orientation, length and width. In an embodiment, color and fluorescent dyes and small interfering ribonucleic acid (RNA) are encapsulated inside the tubules. For example, fluorescent cholesterol-NBD incorporated into the tubule bilayer demonstrates the potential of controlling surface properties of the tubule.

### BRIEF DESCRIPTION OF THE DRAWINGS

FIG. 1(a) shows lipid vesicles dispersed between glass surfaces.

FIG. 1(b) shows the perimeter (edge) of the confined region, with capillary flow causing outward migration of lipid vesicles (arrows).

FIG. 1(c) shows tubules elongated from the perimeter of the confined glass surfaces.

FIG. 1(d) shows an oriented tubule assembled from lipid vesicles entrapping a dye (hash marks).

FIG. 1(e) shows a ternary phase diagram of lipid-ethanol-water at 22° C. for self-assembly of tubules.

FIG. 1(f) shows interconnected tubule structure formed from region IV.

FIG. 2(a) is a schematic showing the cross-section of a lipid tubule grown between glass confinements. The head of the tubule is in contact with the glass surfaces.

FIG. 2(b) is a schematic showing the hydration gradient established by the evaporation of liquid from around the perimeter of the glass confinement. The tubules T1 and T2 grew from a region of lower water concentration towards a region of higher water concentration.

FIG. 2(c) shows lipid tubule growth over 60 min. with different lipid concentrations.

FIG. 2(d) shows the growth trend of lipid tubules over 12 h.

FIG. 3(a) shows encapsulation of Cy3 labeled siRNA in tubules.

FIG. 3(b) shows branched tubules. The tubule was created from vesicles with lecithin and NBD labeled cholesterol.

FIG. 3(c) shows branched tubules cooled at 22° C. for 3 min. The branches were formed from the main tubules, which are indicated by the arrows in (b and c).

FIG. 3(d) shows a bent tubule. After bending, UV-polymerized diacetylene tubules demonstrated structural stability and flexibility.

FIG. 3(e) shows a lipid vesicle (indicated by the arrow) was carried in between the exterior tubular spacing formed between the two moving pearls. The aqueous phase was labeled with a mixture of blue and red aqueous dye, giving it a purple appearance. The pearls moved toward the distal end (right) of the tubule and transported the lipid vesicle along the tubule. Eventually, fusion of the pearls unloaded the vesicle downstream on the tubule.

FIG. 4 is a schematic representation of various applications for lipid tubules.

FIG. 5 is a schematic representation showing the structure of lipid tubules.

FIG. 6 is a schematic showing various applications for lipid tubules and mechanism by which such applications may be achieved.

FIG. 7 shows various methods of making and using liposomes as compared to tubules.

FIG. 8 shows various advantages and disadvantages of liposomes and tubules.

FIG. 9 shows various tubule preparation methods.

FIG. 10 is a schematic showing the instant method of making tubules.

FIG. 11 shows environmental applications of tubules.

FIG. 12 shows biotechnology applications of tubules.

FIG. 13 shows electronics applications of tubules.

FIG. 14 shows medical applications of tubules.

### DETAILED DESCRIPTION

Embodiments of the invention described herein relate to a method for generation of tubules between two confined hydrophilic surfaces, for example, glass surfaces. The tubules formed, such as lipid tubules, generally have defined orientation, width and length. The method allows generation of tubules in excess of 10 mm, up to 13 mm or more, under ambient conditions without externally supplied flow, temperature control or catalyzing agents. Tubule membranes and the internal contents of the vesicles can be manipulated by controlling the combination of different vesicle's lipid composition and contents, or aqueous entrapment. The self-assembly process opens up new pathways for generating complicated and flexible architectures for use in biocompatible molecular and supramolecular engineering. While the description herein refers to lipids in some embodiments, it is understood that the method extends to use with any amphilic compound, defined herein in some embodiments as a compound comprising at least two groups that are mutually insoluble. Such compounds include, for example, soaps, detergents and other surfactants.

Generally, the method comprises depositing an aqueous solution comprising lipid vesicles onto a substrate, confining the aqueous solution to a region comprising a top, a bottom, perimeter and a center, and allowing the aqueous solution to evaporate at the perimeter. The confined region, in some preferred embodiments is defined by a hydrophilic substrate such as, for example, a glass slide; and a hydrophilic cover over the aqueous solution, for example a glass cover slip. The aqueous solution then is allowed to evaporate at the perimeter of the confined region, e.g., the perimeter of the glass cover slip. Under such conditions, the lipid tubules self-assemble. As used herein, the term “self-assemble” is intended to mean that the tubules assemble as a result of specific local interactions between the components themselves, without external input. It is, however, contemplated that external input, although not necessary, may be employed in some embodiments. Such external input may relate to, for example, manipulation of temperature, pressure, humidity, flow, or any other parameter that is amenable to manipulation.

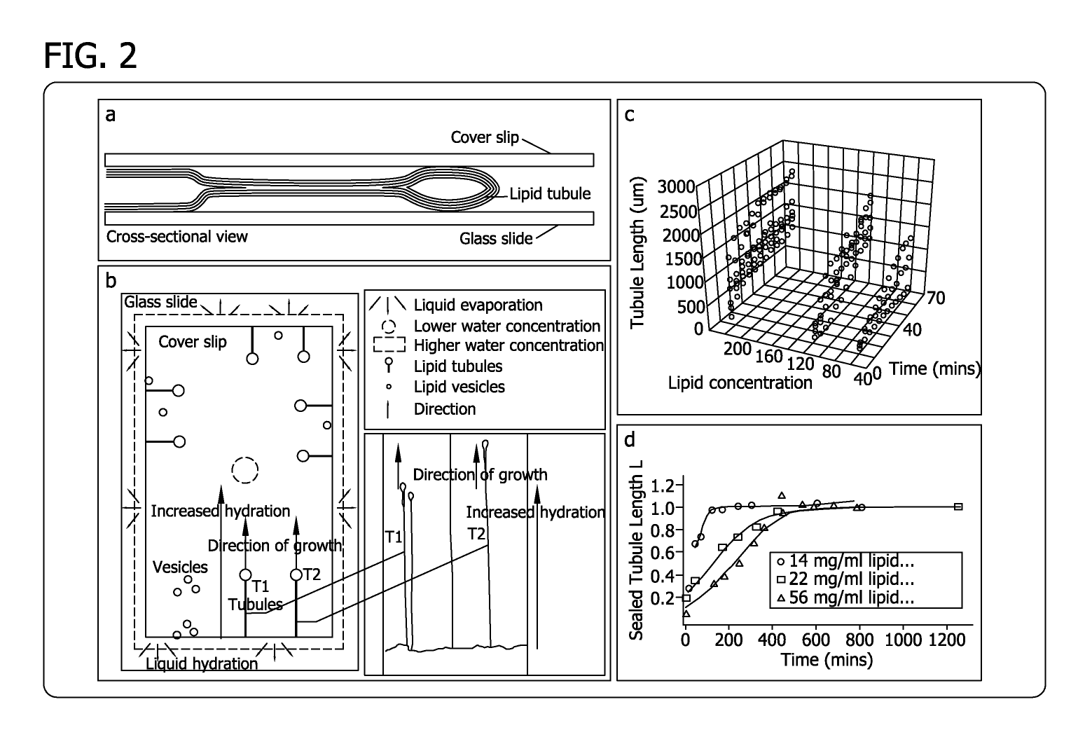

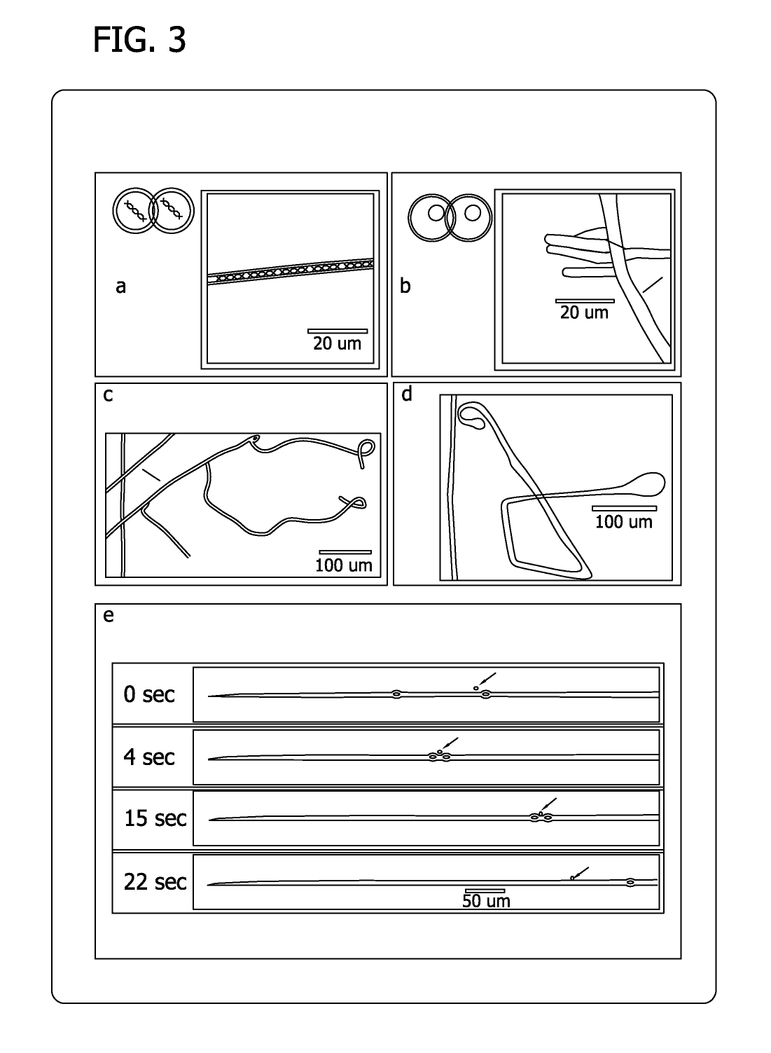

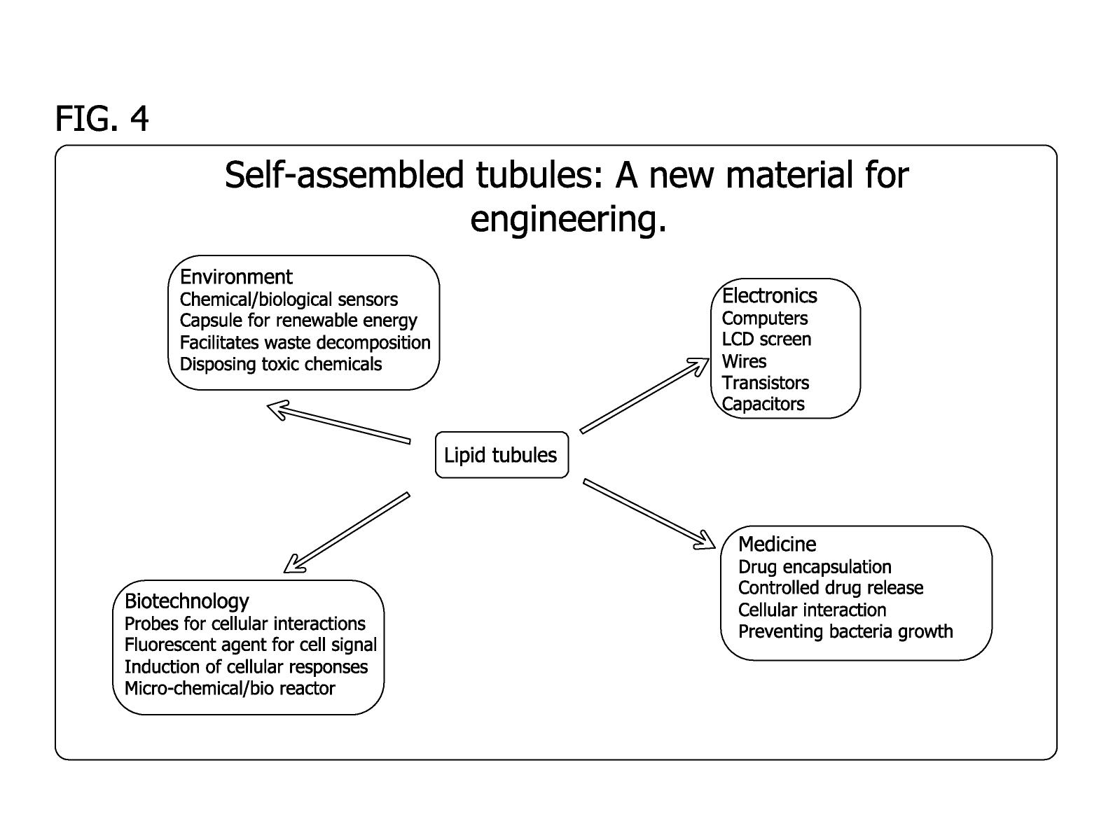

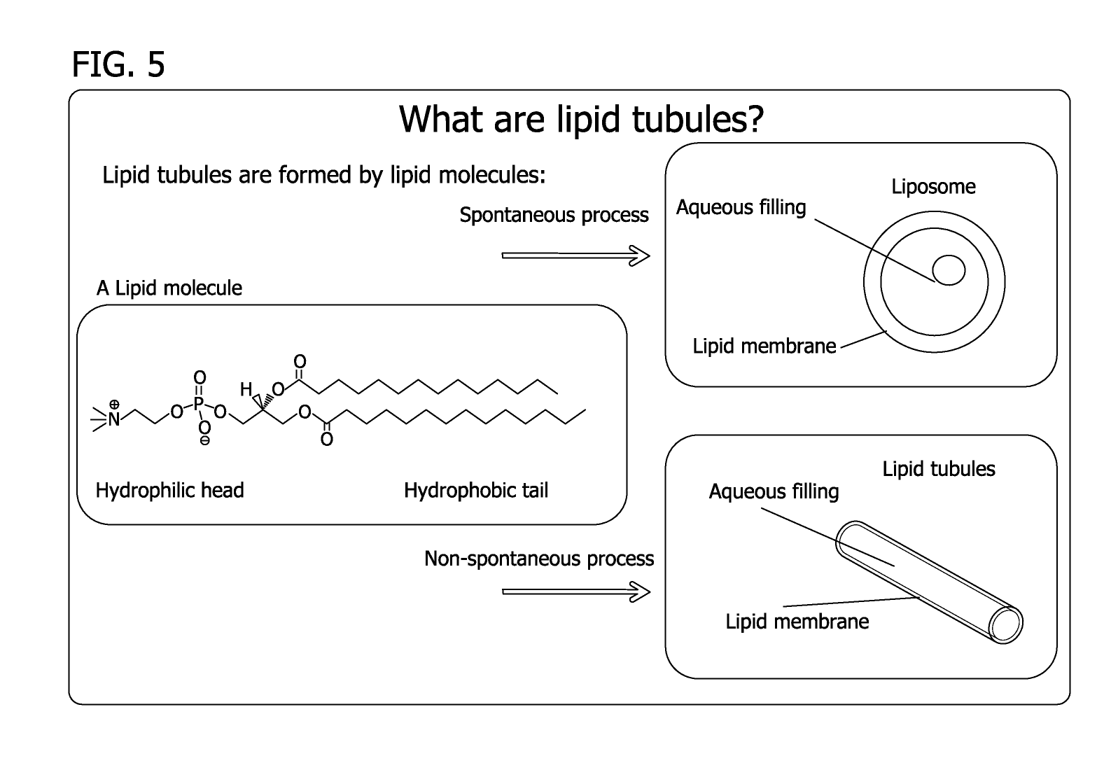

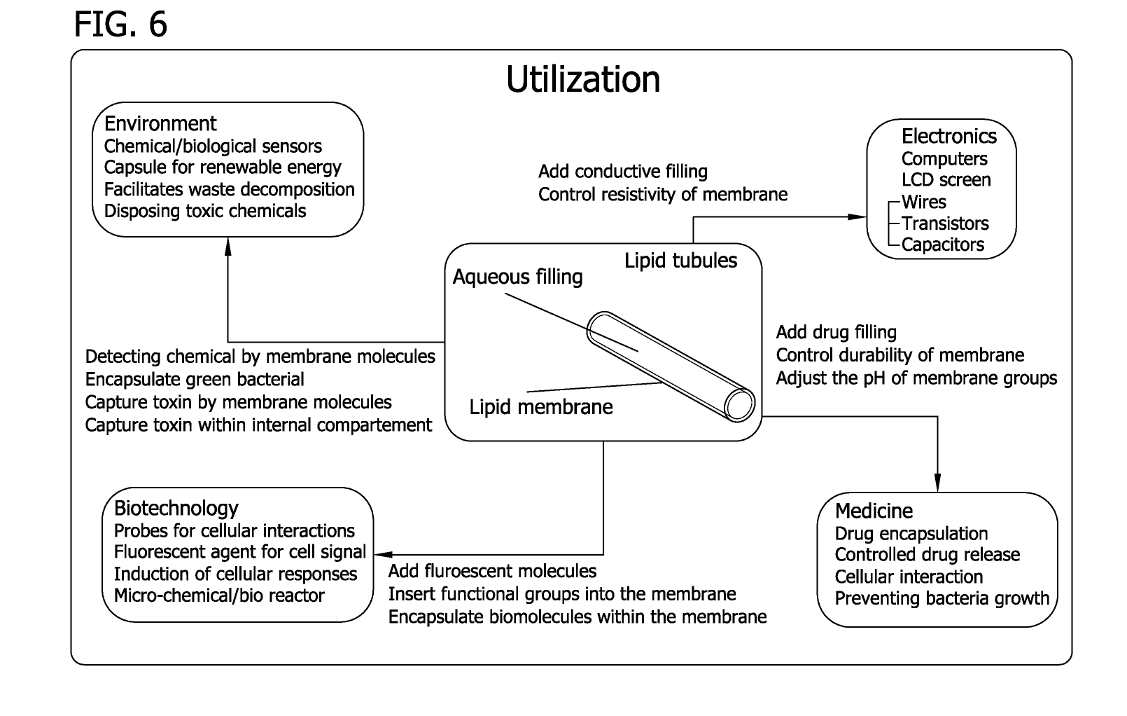

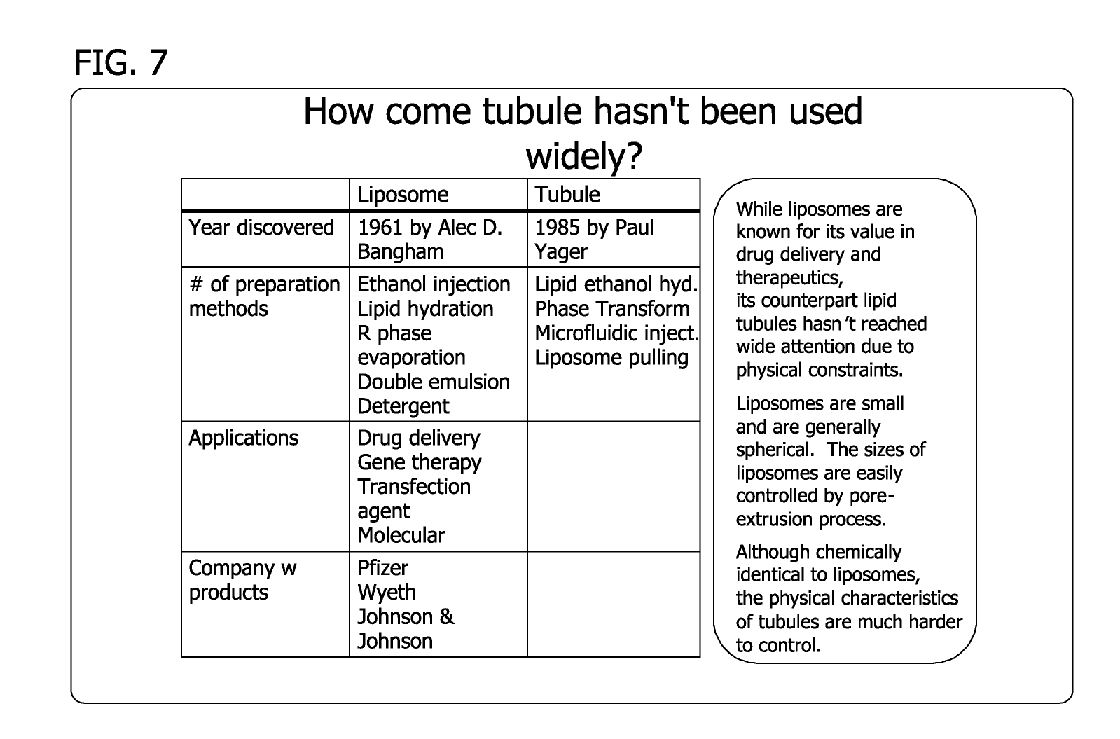

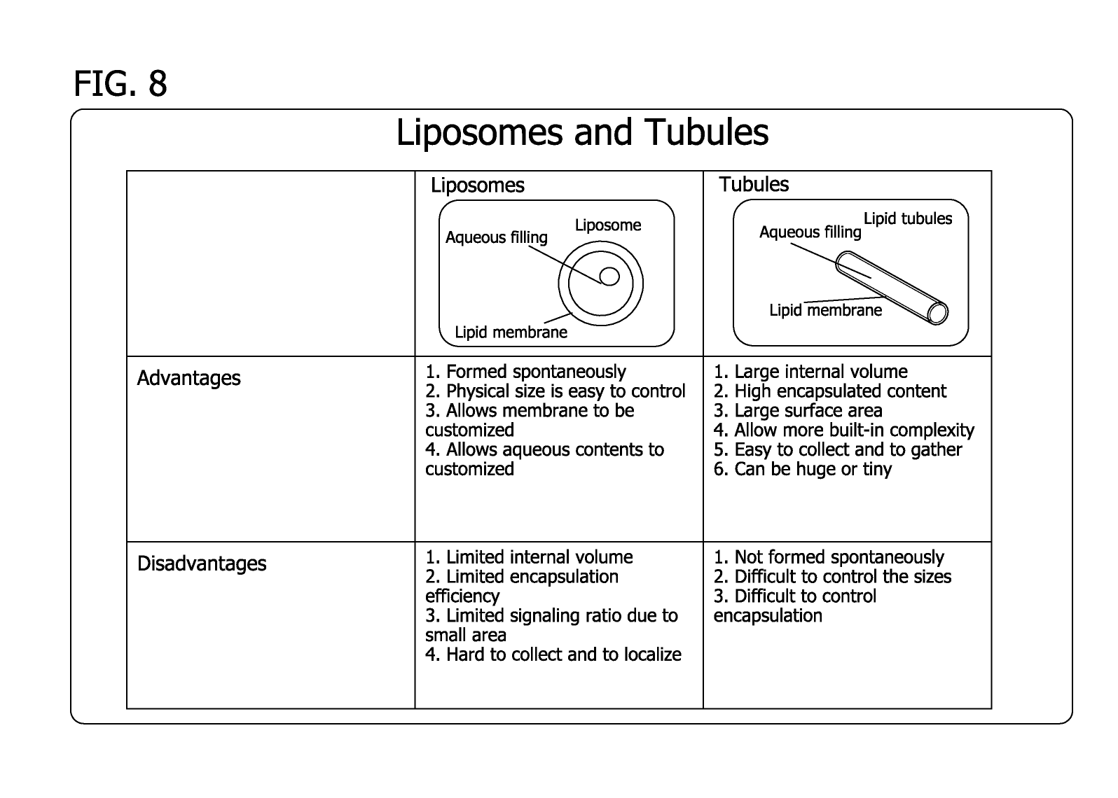

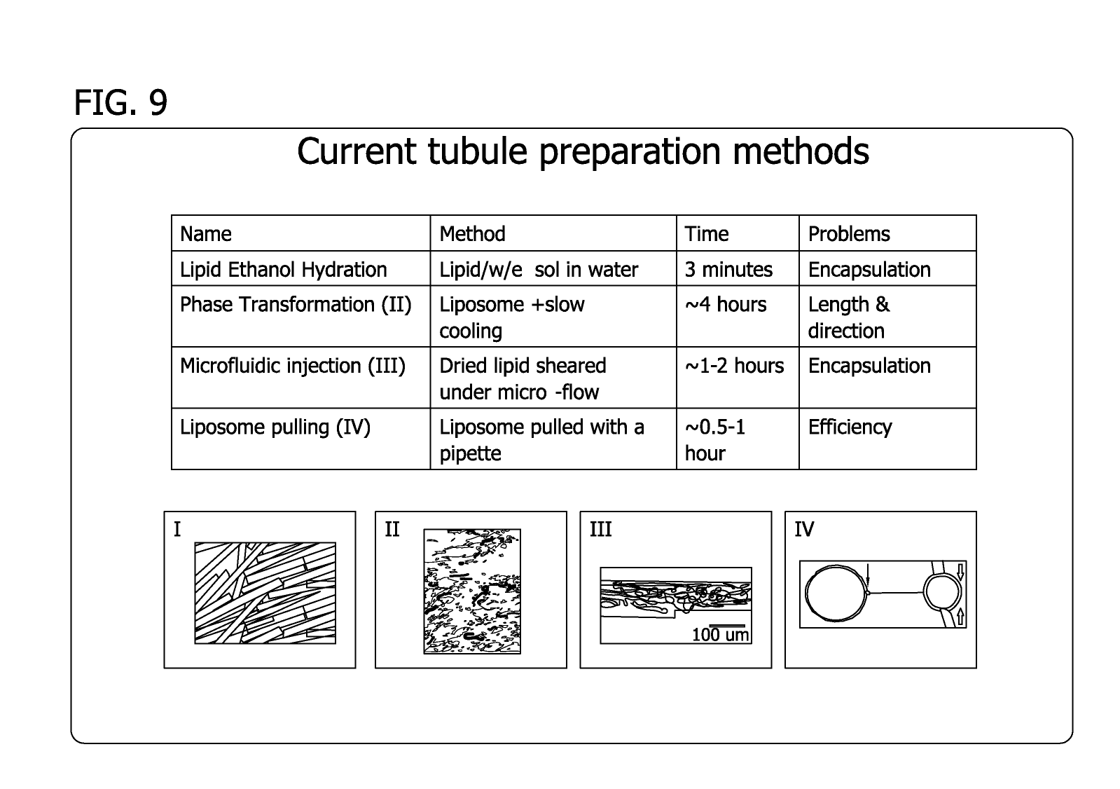

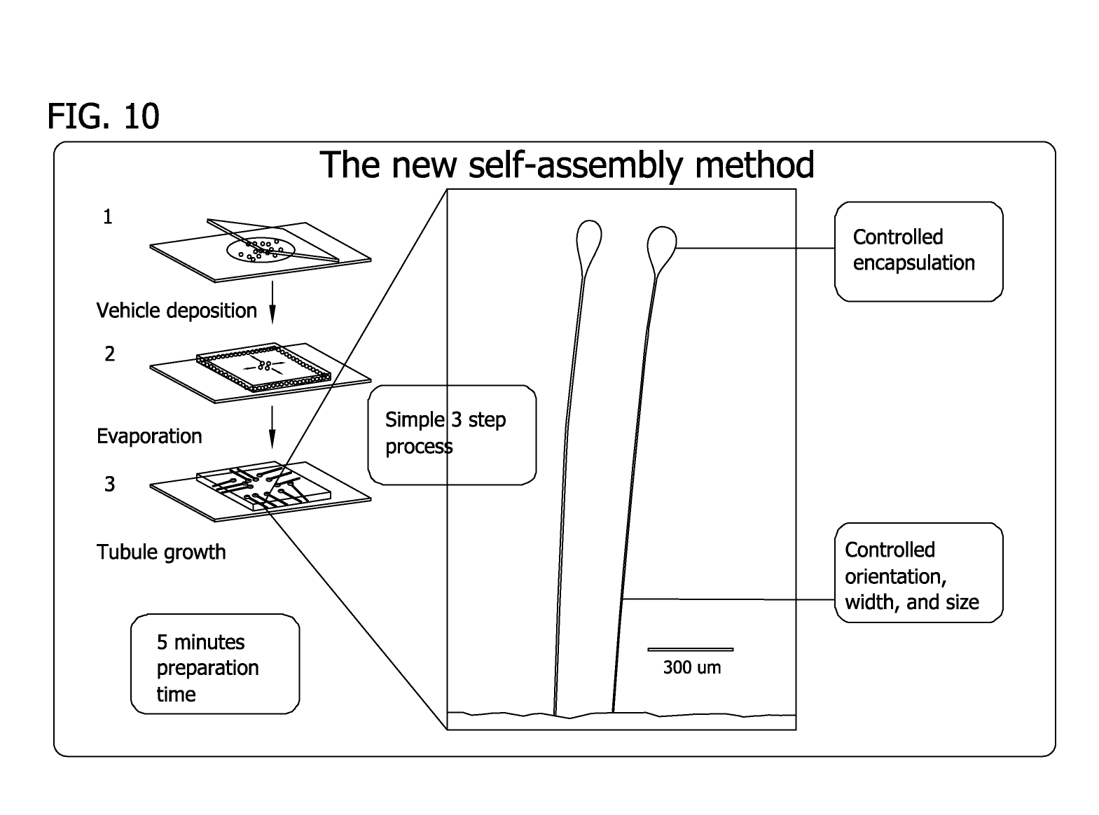

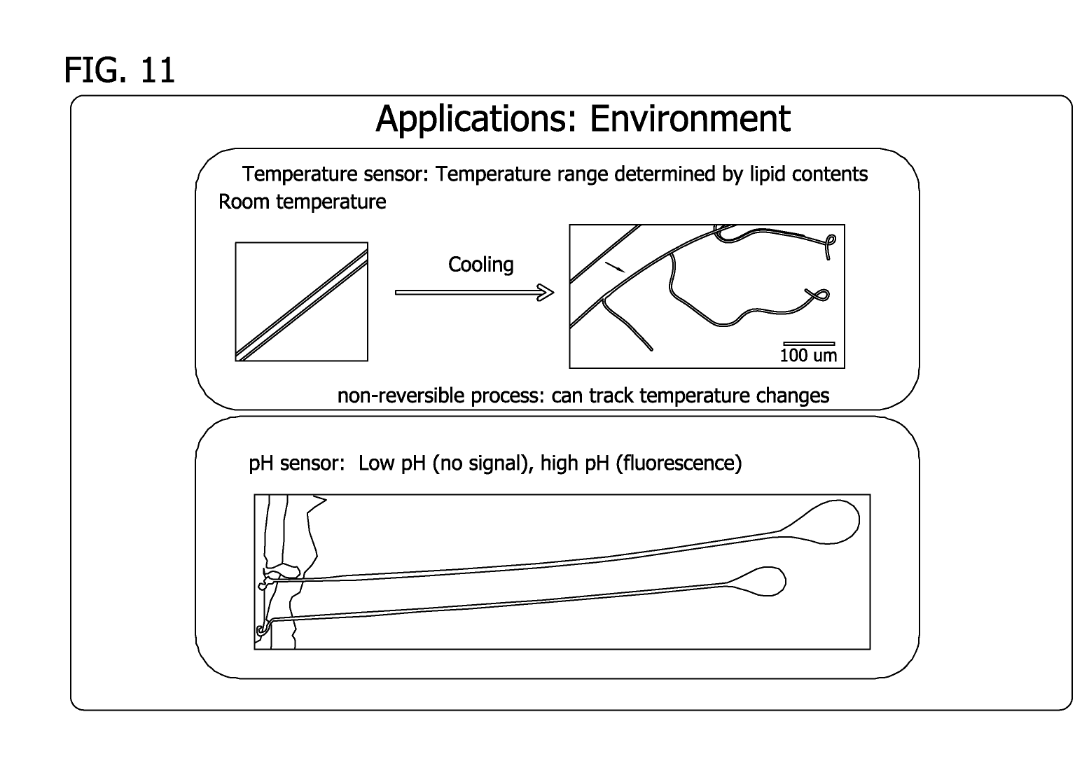

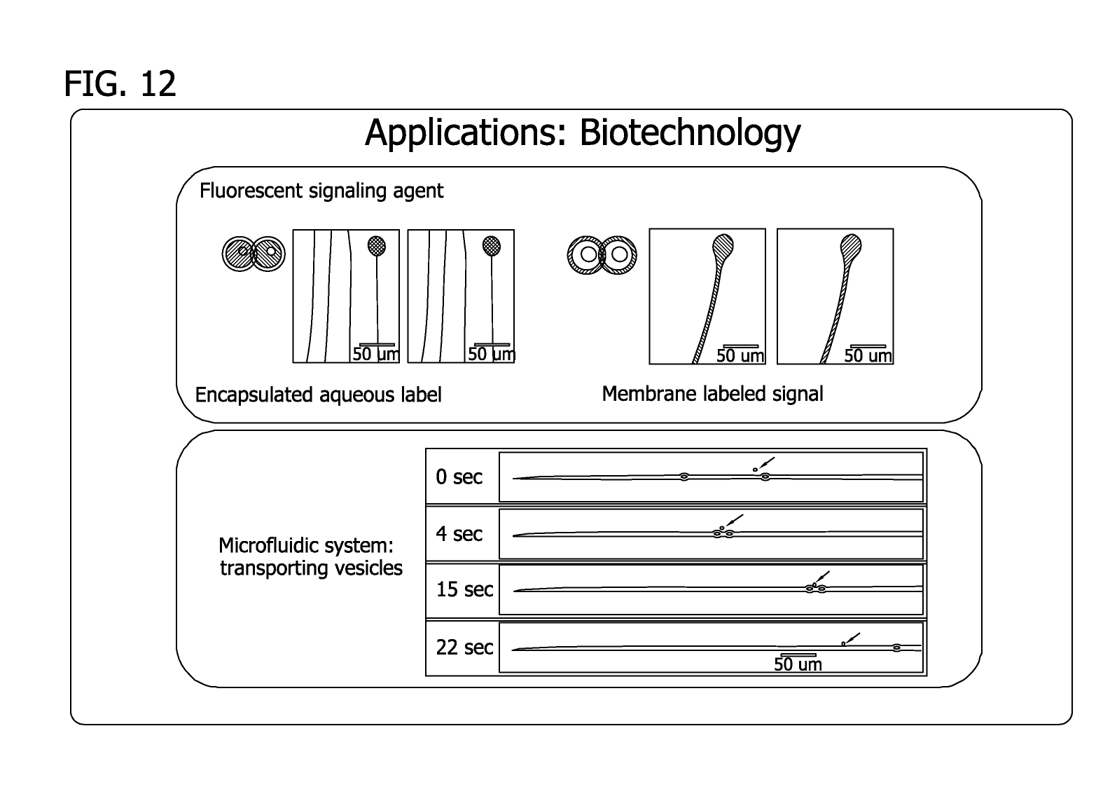

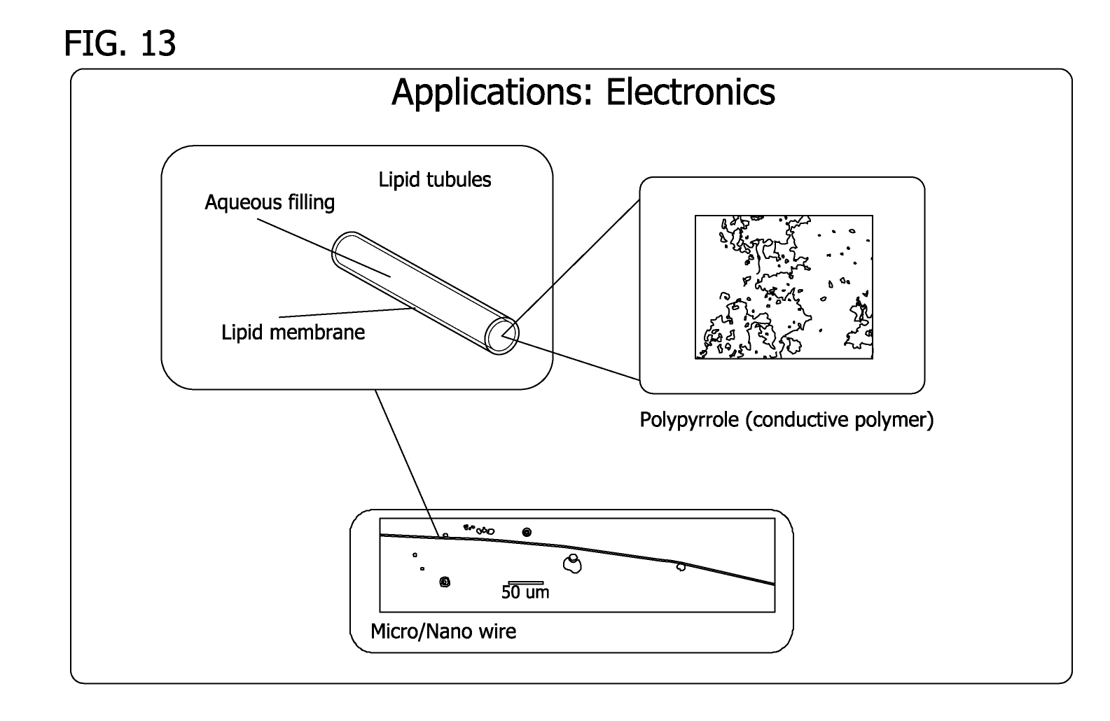

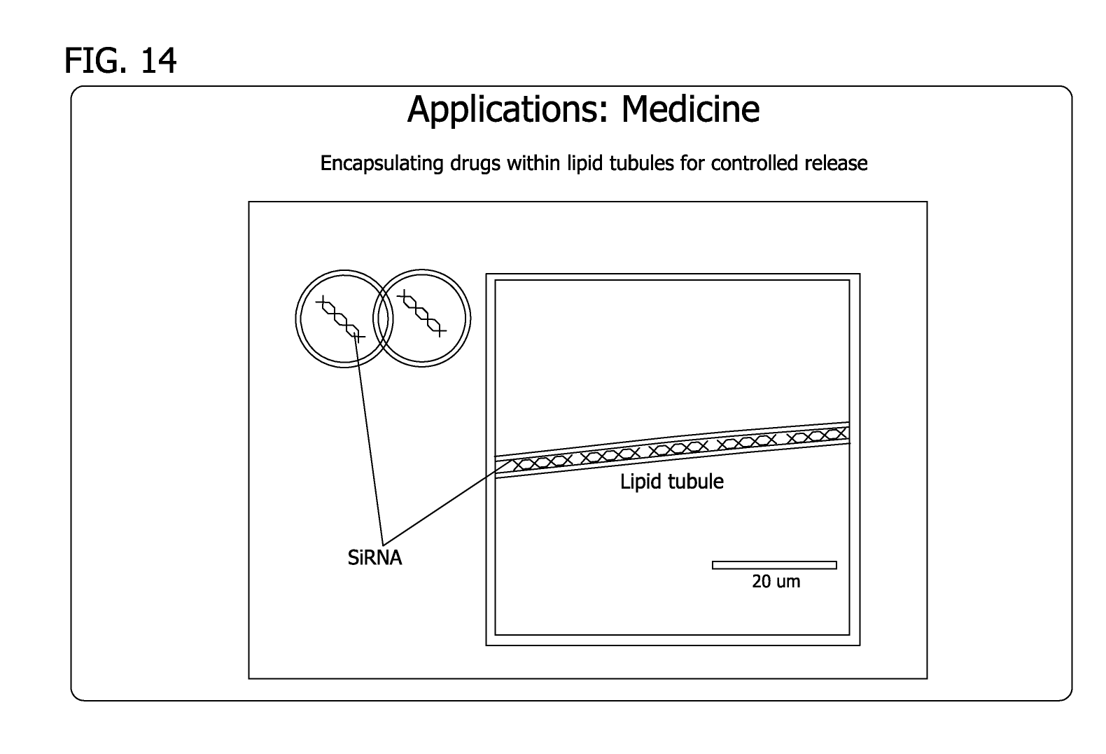

While not being held to any particular theory, a two-step mechanism for the formation of oriented tubules from fused lipid vesicles is proposed. For example, prior to tubule growth, the liquid evaporation around the perimeter of the confined hydrophilic surfaces generates a continuous hydration gradient from the perimeter to the center of the confined region. Initially, the growth is similar to that of myelin figures (Buchanan, M. et al., Langmuir, 2000, 16:3718): the lamellar phase grows into “buds” between the two surfaces to establish a chemical equilibrium with the aqueous phase. When the buds become large enough to be in contact with both the top and bottom surface (FIG. 2(a)), they start to spread from the perimeter toward the center of the confined region. This type of motion can be interpreted as resulting from the formation of a gradient in surface tension or adhesion of the lipid for the substratum that coincides with the hydration gradient from the perimeter to the center of the confined region. The isolated vesicles and the globular head of the tubules migrate from areas of lower, to areas of higher, surface tension or “wettability”, thereby decreasing the free energy of the system (Gennes, P.-G. et al., Capillarity and Wetting Phenomena, Springer, 2003). This interfacial tension-driven growth is supported by observations of the movement of large isolated vesicles from the perimeter toward the center of the confined region and the lack of tubule growth towards the center for branched tubules that do not possess globular heads (FIG. 3(b), 3(c)). FIG. 2(b) shows the hydration gradient established by the evaporation of water from around the edge of the confinement. The evaporation process increases the concentration of vesicles by removing the water surrounding the vesicles. Eventually, an increased hydration gradient is established from the perimeter of the confined region towards the middle of the confined region. However, once the tubules form, regardless of the location of the hydration gradient, the tubules generally grow in a straight line. As illustrated in FIG. 2(b), the hydration gradient causes the growth of both tubules T1 and T2, but it will not significantly change the growth direction of T2.

This proposed mechanism for oriented tubule growth is different from previous tubule formation techniques. Unlike tubules formed from saturated lipid-water solution, temperature induced phase transition is not the direct cause of tubule growth in the instant method, since the tubules may be synthesized under constant temperature. Flow induced growth (Brazhnik, K. P. et al., Langmuir, 2005, 21:10814; Dittrich, P. S. et al., Lab Chip, 2006, 6:488; Lin, Y.-C. et al., Sens. Actuators, B, 2006, 117:464) is also not the driving mechanism, as the tubules often grow against the direction of the flow. It has been observed that when the lipid vesicles were stabilized by nano-sized charged beads (Zhang, L. and Granick, S., Nano Lett., 2006, 6(4):694), no tubules were generated, suggesting that the fusion of vesicles may be a potentially important part of this self-assembly process. In addition, no tubules were generated when two hydrophobic surfaces were utilized (e.g. teflon surfaces and PDMS surfaces), which may indicate that the hydrophilic surface interaction with the lipid molecules is important to tubule growth. The gap size (e.g., the gap between the top and bottom hydrophilic surfaces) appears to be of some importance for tubule formation. Tubule growth was tested in glass confinement created by nickel spacers of 50 μm and 100 μm (McMaster-Carr # 8912k71). None of the confinements at those heights generated any oriented tubules. Thus, the gap between the hydrophilic surfaces is preferably less than about 40 μm, more preferably less than about 25 μm, more preferably less than about 20 μm, more preferably between about 5 μm and about 20 μm, and even more preferably between about 10 μm and about 20 μm. 15 μm is a particularly preferred gap.

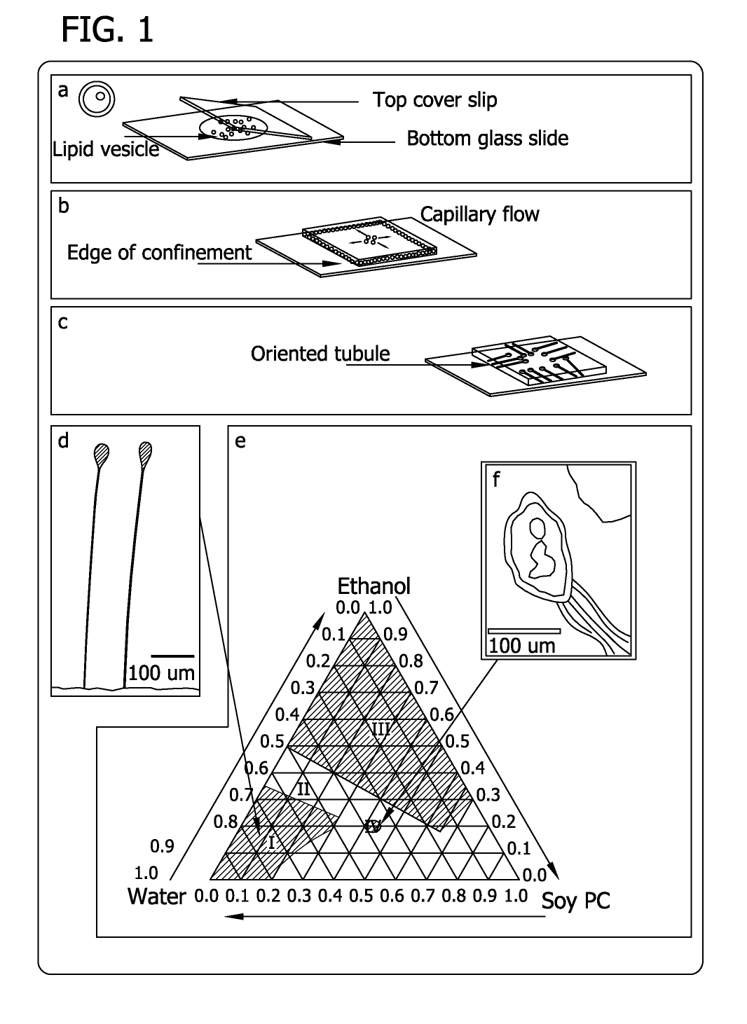

In earlier studies (Thomas et al.; Schnur et al.; Yager et al.), saturated lipid-ethanol-water solution (region III, FIG. 1(e)), which is free of vesicles, formed tubules through the controlled cooling of temperature to below the lipid phase transition temperature.

In the experiment described herein at Example 1, the lipid structures generated from region I, II, and IV occurred at room temperature, or about 22° C., which is above the lipid phase transition temperature (−15+5° C.). In the lower left corner of the phase diagram (FIG. 1(e)), within region I, tubules created in the absence of ethanol may be formed from vesicle solutions containing 0.064% to 19.4% (w/w) lipid. These tubules are stable for weeks when kept under hydrated conditions. Further increases in lipid concentration prevent tubule formation and instead a lamellar phase may form around the perimeter of the confined region. The addition of ethanol increases the solubility of the lipid phase, thus allowing tubule formation at higher lipid concentrations. However, when the ethanol concentration was increased to beyond region I, the lipid bi-layer became too fluid to support tubules, creating unstable tubules that, although structurally similar to stable tubules, melted into a lipid lamellar phase within 10 min of formation (region II).

When the ethanol concentration exceeded 34% (w/w), the lipid solution became clear and no vesicle formation was observed. At sufficiently high lipid concentration, the formation of interconnected tubules was observed (FIG. 1(f)), where short tubules are connected to different lipid globules (region IV). In contrast to previously reported vesicle self-assembly systems, the range of lipid concentration that can give rise to oriented tubules is much broader in the method described herein. Further, the vesicle assembly process described herein is biocompatible, as the assembly can occur without the presence of ethanol, which can denature proteins. Thus, a wide selection of conditions for tubule growth, with improved compatibility for generating complex and functional architectures is made possible.

To understand the growth dynamics of oriented tubules, tubules were prepared in the absence of ethanol by first heating the vesicle solution between confined glass surfaces for 3 min at 60° C. Tubules were allowed to grow at room temperature (˜22° C.) for over 8 h. The oriented tubules aligned themselves almost perpendicularly (90°±20°) to the perimeter of the cover slip during the initial assembly; though the tubules could bifurcate or bend past obstacles, such as lipid vesicles during growth. The variation in orientation was likely caused by capillary flow created during the evaporation process. The growth rate of oriented lipid tubules was non-steady and varied from about 3-225 μm min⁻¹. The length and width of tubules grown for 60 min are shown in Table 1. The growth rate averaged 25 μm min⁻¹ over the first hour and the length plateaued within 12 h, reaching an average length of 6.3 mm and a maximum length of 13 mm. The average maximum tubule lengths are listed in Table 2. When the tubules grew beyond 3 mm, the physical contact between tubules interfered with the growth, contributing to a large variance (50%) in the final tubule lengths. In previous studies, tubules self-assembled directly from phospholipids have only reached lengths of 10-500 μm, and rarely reach centimeters long without alignment by an externally applied flow.

TABLE 1
Average tubule length and width over 60 min ^{a}

| Lipid concentration - mg mL⁻¹ | Length - μm | Width -μ |
|---|---|---|
| 215 | 1755 (26%) | 6.8 (4%) |
| 107.5 | 1815 (20%) | 6.3 (2%) |
| 53.75 | 916 (60%) | 5.2 (4%) |

^{a} percent of variation is shown in parentheses

TABLE 2
Average tubule length and width over 12 h ^{a}

| Lipid concentration - mg mL⁻¹ | Length - μm | Width -μ |
|---|---|---|
| 56 | 4603 (62%) | 5.6 (6%) |
| 22 | 8866 (47%) | 5.0 (8%) |
| 14 | 5716 (11%) | 4.8 (4%) |

^{a} percent of variation is shown in parentheses

FIG. 2(d) shows the dimensionless tubule length (tubule length scaled with the maximum tubule length achieved in equilibrium) versus time. The data can be fitted with a phenomenological model that coincides with the logistic growth model for population dynamics (Banks, R., Growth and diffusion Phenomena: Mathematical Frameworks and Applications, Springer-Verlag, 1994). The tubule length L follows in Eq. (1),

$$d L / d t = a L ( 1 - \frac{L}{{L}^{*}} ) \qquad ( 1 )$$

where a is the intrinsic growth coefficient and L* is the maximum tubule length as time reaches infinity (e.g. at equilibrium). L* is an average value for multiple tubules observed in each sample. With initial condition L=L₀ at t=0, Eq. (1) can be solved as shown in Eq. (2):

$$\frac{L}{{L}^{*}} = \frac{1}{1 + ( \frac{{L}^{*}}{{L}_{0}} - 1 ) {e}^{- at}} \qquad ( 2 )$$

Both L₀ and L were taken from the experimental data. Fitting the model to the data, the growth coefficient, a, was determined to be 0.03 min⁻¹, 0.01 min⁻¹, and 0.01 min⁻¹ and the equilibrium tubule lengths were 4605 μm, 4974 μm, and 8531 μm, corresponding to lipid concentrations at 14 mg mL⁻¹, 22 mg mL⁻¹, and 56 mg mL⁻¹, respectively. The results from the model indicate that tubules reached equilibrium faster with lower lipid concentration, such as 14 mg mL⁻¹, but when the concentration reaches beyond 22 mg mL⁻¹, there is no significant difference. It was also observed that the width of the tubules increased with increasing lipid concentration, which agrees with previous findings that an increased lipid concentration leads to increased number of tubule bi-layers.

The construction of oriented tubules from individual nanosized vesicles can allow a variety of composite tubules to be formed through varying the properties of the individual vesicles. This hypothesis was verified with the following experiments. First, to determine whether the lipid contents from different lipid vesicles are mixed during the formation of oriented tubules, two sets of lipid vesicles were labeled, each with a distinguishable lipid probe (Bodipy FL phosphatidylcholine, green, and Texas Red DH-phosphatidylethanolamine, red) and then briefly mixed before the tubule assembly occurs to ensure that the labeled vesicles were equally distributed between the glass surfaces. The fluorescence of the two fluorophores was later monitored during tubule formation by laser scanning microscopy. Each resulting tubule showed an equal distribution of the two fluorophores, demonstrating that the lipid membrane of the individual vesicles had mixed during the formation of the tubules.

Next, to determine whether the aqueous contents of distinct lipid vesicles are mixed during formation, two sets of lipid vesicles were labeled, each with a distinguishable aqueous fluorophore (FITC, green and Texas Red maleimide, red). Similar to the lipid mixing experiment described above, the assembled tubules also showed an equal distribution of aqueous labels inside tubules, indicating that the aqueous contents of the individual vesicles had mixed during tubule formation.

Using a combination of lipid label (Bodipy FL phosphatidylcholine) and aqueous label (Texas Red maleimide), the internal structure of the oriented tubules was assessed by measuring the intensity and the distribution of the two labels. Since Bodipy FL is sensitive to laser bleaching, brief exposure of the mid-plane of the tubule revealed the contributions of the two fluorophores. In some tubules, the strong lipid signal remained in the center of the tubule after bleaching, indicating a tube-in-tube structure. In most tubules, however, the photo-bleaching at the mid-plane revealed the aqueous label in the middle of the tubule before the bleaching of the fluorescence at the edges. This observation suggests that the lipid concentration is lower at the center, compared to the edges of the tubule. In contrast to the lipid label, the aqueous label in the mid-plane yielded a higher signal, appearing as a bright band at the center of the tubule. Laser scanning through vertical segments of the tubule also showed the maximum distribution of aqueous dyes in the center. This distribution of the aqueous labels within the tubule is different from the lack of fluorescence in myelin tubes, which are bi-layered systems with no significant aqueous core (Kennedy, A. P. et al., Langmuir, 2005, 21:6478). Therefore, the tubule structure most consistent with all the data is a long aqueous core wrapped by multiple lipid bi-layers. This is further supported by the observation of traveling lipid structures, commonly referred to as pearls, along with oriented tubules. The traveling pearls were previously known to occur on tubules formed spontaneously by blood cells (Iglic, A. et al., Phys. Lett. A, 2003, 310:493) and on tubules stimulated by optical tweezers (Bar-Ziv, R. and Moeses, E., Phys. Rev. Lett., 1994, 73(10):1392). The observation of pearls supports the presence of long aqueous channels in these tubule systems. The pearls generally travel from the confined glass perimeter (proximal end) to the distal end where they eventually merge with the head of the tubule. Occasionally, the pearls traveled from the distal toward the proximal end. The combination of the bi-directional movements of pearls reveals a new molecular transport system (FIG. 3(e)). The exterior tubular spacing formed between two moving pearls can transport vesicles on the surface of the tubule. This new phenomenon can potentially be used as a bi-directional transporter in a Lab-On-Chip system, where cells, biomolecules, and vesicles can function as detection units that are transported on the surface of tubules by the moving pearls. The occurrence of pearls can be increased by growing tubules from vesicles encapsulated with sodium chloride solution.

The encapsulation of biomolecules within lipid vesicles has already enabled many applications, including drug delivery and in vitro protein synthesis. These applications may be realized by tubules as well. One potential barrier to progress in this regard is the challenge to transfer molecules into the tubules without additional encapsulation or purification steps after tubule formation. For example, with polymerized tubules synthesized from diacetylene lipid, the tubule structures are solidified upon exposure to UV, thereafter, polymerized tubules can be transferred to an environment that would allow biomolecules to diffuse into these tubules (Meilander, N. J. et al., J. Controlled Release, 2003, 88:321). Such an encapsulation process is limited by diffusion and is not possible with non-solidified tubules, as the process would disturb the shape of the tubules. An advantage of the instant tubule assembling process is its flexibility that allows the molecule encapsulation to be optimized and the bi-layer composition to be varied during the tubule assembly process. It is demonstrated herein that therapeutic biomolecules, such as siRNA, can be incorporated into the tubule by assembling tubules from siRNA-containing lipid vesicles (see FIG. 3(a)). Furthermore, the tubules may form branches. Such branches are consistently formed when cholesterol is incorporated into the vesicles (FIG. 3(b)). For tubules without cholesterol, such branching morphologies can be induced by cooling lecithin formed tubules briefly. In an embodiment, the tubules are cooled below 0° C., more preferably below −10° C. and even more preferably below −20° C.; for less than about 10 min, more preferably less than about 5 min and even more preferably less than about 3 min (FIG. 3(c)). The originally straight tubules become branched after the cooling cycle. The duration of cooling affects the length of the branches. When the cooling duration lasted longer than 10 min, the tubules, when brought back to 20° C., became fragmented into short tubules. Due to the purity of the lipid tubule system, the branch formation can be linked directly to the change in the physical properties of the lipid bi-layers in response to temperature, thus making this tubule system a potential model for membrane studies. Finally, by combining diacetylene vesicles with vesicles incorporated with Texas Red DH-phosphatidylethanolamine, fluorescent solid tubules were created by polymerizing the tubules upon exposure to UV. Diacetylene tubules were first grown from diacetylene vesicles dispersed between glass confinements. The grown tubules were then exposed to UV under an UV illuminator for 5 min to polymerize the diacetylene lipids. FIG. 3(d) shows a polymerized tubule bent by moving the cover slip. The tubule was proven to be structurally robust, such that the tubules can be bent without breaking. After removal from the glass confinement, the polymerized tubules were stable. For non-polymerized tubules, such as lecithin tubules, they could either remain in the tubule form or retract to become large vesicles.

To determine the range of lipid concentrations that can generate oriented lipid tubules, ethanol-free and ethanol-containing vesicles were prepared. Although alcohol is not required for oriented tubule formation with the method described herein, it is required for many other tubule formation methods reported in the literature (Chiruvolu, S.; Thomas, B. N. et al., Science, 1995, 267(5204):1635; Schnur, J. M. et al., Science, 1994, 264(13):945; Yager, P. et al., biophys. J., 1985, 48:899). In addition, alcohol, a co-surfactant, can increase membrane fluidity, such that continuously increasing the ethanol concentration will eventually lead to the transition between stable and unstable tubules. The effects of ethanol in the tubule formation system described herein were investigated. The ternary diagram shown in FIG. 1(e) illustrates the different tubule types created by varying the lipid, water, and ethanol concentrations in the aqueous solution. Thus, lipid concentrations may range, for example, from 0.0064% to 19.4% (w/w) lipid; or alternatively, from about 0.001% to about 20% (w/w) lipid; or alternatively from about 1% to about 20% (w/w) lipid; or alternatively from about 5% to about 15% (w/w) lipid.

### EXAMPLE

Lipid vesicles were prepared from 95% lecthin (Soy PC from Avanti Polar Lipids Inc.) by two different methods. In the first, ethanol solution containing dissolved phospholipids was injected into purified DI water. In the second, a dried film from lipid dissolved in chloroform was first prepared followed by removal of the solvent under vacuum, and then lipid vesicles were prepared by hydrating the film in distilled water with shaking. The vesicles produced by both methods were then extruded through 100 nm polycarbonate pores (Avanti Polar Lipids Inc.), to form vesicles with an average diameter of 130 nm, as characterized by a particle-sizer (90 Plus/BI-MAS Brookhaven Instruments Co.). Both methods have been shown previously to generate unilamellar vesicles (Driessen, A. J. M. et al., Biochemistry, 1995, 34:1606-1614 and Pons, M. et al., Int. J. Pharm., 1993, 95:51-56).

Tubules were prepared by depositing a 30 μL droplet of aqueous solution containing lipid vesicles into the confined volume (22 mm×22 mm×15±5 μm) created by a cover slip sitting atop a glass slide (FIG. 1(a)). The distance between the cover slip and the glass slide was measured by optical means using a confocal microscope. Evaporation of the liquid between the two glass surfaces caused an outward capillary flow that transported vesicles to the edges of the confined surfaces (FIG. 1(b)); a process similar to the ring stains formed from dried liquid drops (Deegan, R. D. et al., Nature, 1997, 389:827; and Shmuylovich, L. et al., Langmuir, 2002, 18:3441). Over time, lipid structures created by evaporation-induced vesicle fusion, grew perpendicularly (in plane) from the perimeter towards the center of the cover slip (FIG. 1c). Leading the growth was a compartmentalized head attached to an elongating tubular tail that can reach 1 cm or more in length (FIG. 1(d)). Due to its unique morphology and orientation, this structure is referred to as an oriented lipid tubule. When vesicles containing different colored dyes were distributed unevenly between the glass confinements, the generated tubules were a mixture of the different colors. While increasing temperature accelerated the formation of oriented lipid tubules, the process itself occurs over a wide temperature range; tubules were assembled within 3 min at 60° C. or within 3 h at 4° C.

The experimental results presented herein suggest that the self-assembly between two hydrophilic surfaces, such as glass surfaces, is a practical method for the production of lipid tubules. Lipid tubules with a variety of properties and functionalities may be constructed by combining vesicle building blocks of different functionalities. The versatility of this tubule assembly process offers new ways to engineer tubule entrapments and compositions, possibly leading to the developments of new classes of composite biomaterials.

Aspects of the invention affect numerous different fields. For drug deliveries, lipid tubules have similar characteristics as liposomes, or lipid vesicles. The hollow interior of the tubules encapsulates drugs or other therapeutic agents and allows the drugs to be released from the lipid tubules in vivo. For biotechnology, the surface of the lipid tubules may be designed to bind to specific targeted biomolecules for rapid sensing and detection. For electrical and material engineering, both the hollow interiors and the controllable tubules surfaces serve as templates for synthesizing micro/nano wires, needles, and sensors. As an example, the exterior surfaces of a tubule may be tagged with metals to allow metal nanoparticles to assemble into wires upon the removal of lipids and the interior of the tubule may be filled with polymers, which are then cured via ultraviolet light into the shape of the needle inside the tubule. For computer industries, these micro/nano wires are made in three dimensions. This potentially improves the productivity of current processors and reduces costs at least due to the self-assembly process. For microfluidics and lab-on-chip applications, the tubules serve as self-assembled fluidic networks to process chemical reactions by similar mechanism as the chips fabricated by the semiconductor methods. The foregoing implementations are merely exemplary, and other applications of the technology are within the scope of the various embodiments of the invention.

Embodiments of the invention are not limited to the particular lipid compositions and aqueous entrapments described herein. Rather, aspects of the invention include numerous other combinations of compositions and entrapments to adjust the encapsulation, growth, orientation, length, and width of the lipid tubules.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for making lipid tubules, the method comprising:
depositing an aqueous solution comprising lipid vesicles onto a substrate;
confining the aqueous solution to a region comprising a top surface, a bottom surface, a perimeter and a center; and
allowing the aqueous solution to evaporate at the perimeter;
wherein the lipid tubules self assemble.

2. The method of claim 1, wherein the region is defined as a volume between the substrate and a cover.

3. The method of claim 2, wherein the distance between the substrate and the cover is between about 10 μm and about 20 μm.

4. The method of claim 3, wherein the distance between the substrate and the cover is about 15 μm.

5. The method of claim 4, wherein the substrate and cover are both glass.

6. The method of claim 2, wherein the substrate is glass.

7. The method of claim 1, wherein the method is carried out at a temperature of between about 4° C. and about 60° C.

8. The method of claim 1, wherein the lipid vesicles comprise cholesterol.

9. The method of claim 1, further comprising cooling the tubules to a temperature of about −20° C. to induce the formation of branches.

10. The method of claim 1, wherein the aqueous solution further comprises alcohol.

11. The method of claim 10, wherein the alcohol is methanol.

12. The method of claim 1, wherein the lipid vesicles comprise diacetylene.

13. The method of claim 1, wherein the substrate is hydrophilic.

14. The method of claim 1, wherein the substrate and cover are both hydrophilic.

15. The method of claim 1, wherein said depositing, said confining, and said allowing occur without externally supplied flow, temperature control, or catalyzing agents.

16. The method of claim 1, further comprising generating a continuous hydration gradient from the perimeter of the confined region to the center of the confined region.

17. The method of claim 1, further comprising establishing chemical equilibrium with the aqueous phase.

18. The method of claim 1, wherein portions of the lipid vesicles migrate from regions of lower surface tension to regions of higher surface tension to create the lipid tubules.

19. The method of claim 1, further comprising forming a gradient in surface tension of the lipid vesicles for a substratum that coincides with a hydration gradient from the perimeter to the center, wherein portions of the deposited lipid vesicles grow as a function of the formed gradient in surface tension to create the lipid tubules.

20. A system for making amphile tubules, said system comprising:
a substrate having deposited thereon a solution comprising amphile vesicles, wherein a cover defines a region of the solution, said region having a top surface, a bottom surface, a perimeter, and a center, wherein the solution evaporates at the perimeter allowing the amphile tubules to self assemble.
